(19) United States
(12) Patent Application Publication
(10) Pub. No.: US 2020/0139845 A1
(43) Pub. Date: May 7, 2020

(54) BATTERY STATE MONITORING SYSTEM AND METHOD THEREFOR

(71) Applicant: Trapeze Software Group Inc., Cedar Rapids, IA (US)

(72) Inventors: Mark Alan HENRICHS, Marion, IA (US); Nathan Thomas REYNOLDS, Marion, IA (US)

(21) Appl. No.: 16/675,571

(22) Filed: Nov. 6, 2019

Related U.S. Application Data
(60) Provisional application No. 62/756,665, filed on Nov. 7, 2018.

(51) Int. Cl. B60L 58/12; G05B 13/02; H04L 12/40

(52) U.S. Cl. CPC B60L 58/12; B60L 2240/60; H04L 12/40; G05B 13/026

(57) ABSTRACT

The present disclosure envisages an on-board battery state monitoring system for monitoring state of charge of a battery of an electric vehicle. The system comprises an onboard processor in data communication with a central server of a transit agency; at least one CAN network for monitoring different parameters of the electric vehicle; a recharge module configured to analyze Parameter Group Numbers (PGNs) in messages broadcasted by the at least one CAN network and filter out PGNs that provide state of charge of the battery, wherein the filtered out PGNs are transmitted to the on-board processor for the state of charge analysis of the battery to determine if an electric vehicle block can be completed.

### RELATED APPLICATIONS

This application claims priority from U.S. Provisional Patent Application No. 62/756,665, filed Nov. 7, 2018, the contents of which are incorporated herein by reference.

### FIELD

The present disclosure relates to the field of electric vehicles. In particular, the present disclosure relates to electric vehicles being employed by a transit agency.

### BACKGROUND

Transit agencies are organizations that provide transit services to end users. Such transit services may include fixed route and on-demand services. In providing such transit services the transit agencies may have a fleet of vehicles of various vehicle types. These transit service vehicles have various on board systems, that can communicate with a central server of the transit agency, for example to receive and provide information related to the transit services (routing, timing, locations, passengers, driving characteristics and vehicle characteristics).

Fleet operators (car rental organization, car share companies, companies that provide remote worker capabilities, and the like) are organizations that have one or more vehicles that provide various transit and transport services to their workers and/or customers.

Some transit agencies and fleet operators have added electric vehicles to their fleet. However, this presents challenges for ensuring that transit services are going to be completed and/or that replacement options are made available in a timely fashion.

With the advancements in the field of electric vehicles and as a measure against pollution, transit agencies are focusing their efforts in employing more and more electric vehicles. As discussed in the previous section of the present disclosure, the use of an electric vehicle as a transit vehicle can have certain drawbacks. For example, the driver of the transit vehicle may leave the transit garage with a vehicle to perform a piece of work, only to later realize that the transit vehicle does not have enough charge to complete that particular piece of work. In view of this, the vehicle runs out of charge in service, stranding passengers while they wait for a replacement bus, and the agency is forced to pay for the bus to be towed or charged enough to be able to drive back to the garage.

To overcome the possibility of such a situation arising, one solution is that the central server of the transit agency be made aware of the state of charge (SOC) of the battery beforehand and during the task. More specifically, the transit vehicle, which may be in constant data communication with the central server, may be selected to perform additional service only if the central server predicts that there is sufficient charge in the battery of the transit vehicle or if there is an in-service charging station nearby the location of the transit vehicle, where the battery of the transit vehicle can be recharged. The present invention envisages a system and a method to execute the aforementioned solution.

### SUMMARY

An on-board battery state monitoring system for monitoring state of charge of a battery of an electric vehicle, the system comprising: an onboard processor in data communication with a central server of a transit agency; at least one CAN network for monitoring different parameters of the electric vehicle; and a recharge module in data communication with the at least one CAN network and the on-board processor, the recharge module configured to analyze Parameter Group Numbers (PGNs) in messages broadcasted by the at least one CAN network and filter out PGNs that provide state of charge information of the battery, wherein the filtered out PGNs are transmitted to the on-board processor for the state of charge analysis of the battery.

The system of claim 1 wherein the state of charge analysis is to determine if the SOC information is enough to complete a schedule task for the vehicle.

The system of claim 1 wherein the state of charge analysis is then transmitted to the central server and based on the state of charge analysis, the central server computes an SOC instruction.

The system of claim 2 wherein if the SOC instruction indicates SOC information is too low to complete the scheduled task, the central server suggests one or more remedial actions.

The system of claim 3 wherein the remedial action comprises redirecting the electric vehicle to an in-service charging station available in the vicinity of the electric vehicle.

The system of claim 3 wherein the remedial action comprises dispatching another vehicle for completing the scheduled task.

A method for monitoring battery state of an electric vehicle of a transit agency, the method comprising: analyzing, Parameter Group Numbers (PGNs) in the messages broadcasted by at least one CAN network onboard the electric vehicle; filtering out PGNs that provide State Of Charge (SOC) of the battery; transmitting the filtered out PGNs to an onboard processor for SOC analysis; transmitting the SOC information to a central server of the transit agency; performing, by the central server, SOC analysis to determine whether the battery of the electric vehicle has sufficient charge to complete a task, wherein on detecting that the charge in the battery is insufficient to complete the task, the central server: redirects the electric vehicle to an in-service charging station available in the vicinity of the electric vehicle; or dispatches another electric vehicle for completing the task.

There is an on-board battery state monitoring system for monitoring state of charge (SOC) of a battery of an electric vehicle, the system comprising: an on-board computing device, on the electric vehicle, in data communication with a central server and a recharge module via one or more controller area networks (CAN); a battery of an electric vehicle, the battery in data communication with a first CAN for broadcast of a first message to the first CAN, the first message comprising a first parameter group number (PGN) related to the battery and SOC information of the battery; the first CAN for receiving the first message and broadcasting the first message; and the recharge module in data communication with the first CAN network and the on-board computing device, the recharge module configured to: receive a set of one or more messages from one or more CAN networks; analyze the PGNs of each message of the set of messages to search for the first PGN; filter out the first message from the set of messages based on searching for the first PGN; and transmit the first message to the on-board computing device for a SOC analysis of the battery.

The SOC analysis may comprise determining, from the SOC information, if a SOC of the battery is enough to complete an electric vehicle block for the electric vehicle.

The SOC analysis may further comprise: obtaining the SOC information from a suspect parameter number (SPN) of the message; determining the electric vehicle block and a portion of the electric vehicle block that remains; predicting the SOC required for the portion of the electric vehicle block that remains.

The predicting may further comprise: looking up a historical required SOC for the portion of the electric vehicle block that remains; adjusting the historical required SOC or the SOC based on a set of variables; comparing the historical required SOC to the SOC.

The SOC analysis may be performed by the on-board computing device or the central server.

Based on the SOC analysis, an SOC instruction may be computed and a remedial action may be suggested and communicated to the on-board computing device, wherein the on-board computing device may be further configured to display the remedial action.

The on-board computing device may be further configured to perform the SOC analysis and the central server may be further configured to compute the SOC instruction.

The remedial action may comprise redirecting the electric vehicle to an in-service charging station available in the vicinity of the electric vehicle and redirecting steps may be displayed on the on-board computing device.

The remedial action may comprise dispatching another vehicle for completing the portion of the electric vehicle block that remains.

There is further a method for monitoring battery state of a battery of an electric vehicle, the method comprising: analyzing, Parameter Group Numbers (PGNs) in a set messages broadcasted by at least one CAN network onboard the electric vehicle; filtering out messages that provide state of charge (SOC) of the battery based on the analyzing; transmitting the filtered out messages for SOC analysis; performing SOC analysis to determine whether the battery of the electric vehicle has sufficient charge to complete a portion that remains of an electric vehicle block to be performed by the electric vehicle.

On detecting that the SOC of the battery is insufficient to complete the portion that remains of the electric vehicle block, the method may comprise computing a remedial action; and communicating the remedial action to an on-board computing device on the electric vehicle, to be displayed on the on-board computing device.

The SOC analysis may further comprise: determining the electric vehicle block and a portion of the electric vehicle block that remains; predicting the SOC required for the portion of the electric vehicle block that remains.

The predicting may further comprise: looking up a historical required SOC for the portion of the electric vehicle block that remains; adjusting the historical required SOC or the SOC based on a set of variables; and comparing the historical required SOC to the SOC.

The remedial action may comprise redirecting the electric vehicle to an in-service charging station available in the vicinity of the electric vehicle or dispatching a second electric vehicle for completing the task.

There is also a method for establishing a body of state of charge (SOC) historical data for batteries of electric vehicles comprising: assigning an electric vehicle block to be performed by an electric vehicle; specifying a set of two or more points, on the electric vehicle block, at which to collect SOC information while performing the electric vehicle block; collecting, by an on-board computing device in data communication with a recharge module, the recharge module in data communication with a first controller area network (CAN) that is in data communication with a battery of the electric vehicle, the SOC information at the each of the points in the set while performing the electric vehicle block; sending the collected SOC information to a SOC usage database; and storing the collected SOC information in the SOC usage database to establish the body of SOC historical data.

The collecting may further comprise the on-board computing device being configured to, for each point in the set: identify an arrival of the electric vehicle at the points; poll the recharge module to obtaining the SOC information from the battery.

The electric vehicle block may be a fixed route transit route and the one or more point to point SOC usage values to collect may be at each fixed route stop on the fixed route transit route.

The SOC information may comprise a SOC, a driver dataset from a database on the on-board computing device, a vehicle dataset and an environmental dataset and wherein the on-board computing device may be further configured to: ping one or more CANs to obtain the vehicle dataset; and collect the environmental dataset.

### BRIEF DESCRIPTION OF DRAWING

The aspects and other features of the subject matter will be better understood with regard to the following description, appended claims, and accompanying figures. In the figures, the left-most digit(s) of a reference number identifies the figure in which the reference number first appears. The use of the same reference number in different figures indicates similar or identical items.

FIG. 1 illustrates a block diagram of an on-board battery state monitoring system for monitoring state of charge of a battery of an electric vehicle, in accordance with an embodiment of the present invention.

FIG. 2 illustrates a block diagram of a method for monitoring battery state of an electric vehicle of a transit agency, in accordance with an embodiment of the present invention.

FIG. 3 illustrates an exploded view of a recharge module dongle, in accordance with an embodiment of the present invention.

### DETAILED DESCRIPTION

The following disclosure describes systems and methods for monitoring battery state of an electric vehicle. It should be noted that aspects of the disclosed systems and methods can be executed in any number of various computing systems, environments, and/or configurations. Further, the embodiments for monitoring battery state of an electric vehicle of a transit agency described hereinafter are exemplary system(s) and method(s) and are not construed to be limiting.

As used herein, the following terms have the following meanings:
a. Historical required SOC: an SOC that was specifically required for a known task or portion thereof.
b. Remedial action: steps to be taken (relating to the vehicle in question and/or to deal with the task that was to be performed by the vehicle in question) if the SOC instruction is that the vehicle in question should not attempt to complete the task.
c. SOC historical information: various information and data related to SOC information and use, including SOC that was used in completing tasks.
d. SOC analysis: processing related to SOC, using SOC information, SOC historical information, historical required SOC, parameters and variables, and the like.
e. SOC information: the state of charge information of one or more vehicles 102, providing the actual state of charge in one or more measurements (power remaining, percentage charge, and the like).
f. SOC instruction: a decision about what to do based on the SOC information and SOC analysis, generally relating to whether the vehicle in question can complete the task or what remedial actions may be required. Examples include “complete task”, “insufficient charge”, “seek re-charge”, “stop at next stop or manifest item” and the like.
g. Variables and parameters: any factor that directly or indirectly (such as causal or correlated) influences charge that is required to complete a task, such as weather, traffic, time of day, passengers, vehicle, vehicle type, speed travelled, and the like.
h. Piece of work, run, block or task (as scheduled and/or adjusted): something the vehicle 102 is supposed to do. A piece of work typically starts when a driver gets into the vehicle and ends when the driver gets out of the vehicle for the day. A piece of work may have one or more runs or blocks (typically from pull-in to pull-out from a depot and/or charging station) where each run or block may consist of one or more schedules to perform, such a route (such as a fixed route having one or more fixed stops) or portion thereof (such as a pattern of a route, such as a short turn or tripper), a manifest (with one or more pickups and/or drop offs, that may change dynamically as the manifest is being performed) or portion thereof, or a trip that an end user is taking (ie a fleet user going to a job site via a path chosen by a GPS device). Piece of work, run, block, schedule, route and task are used somewhat interchangeably herein.
i. Electric vehicle block: A block that is to be driven by a vehicle, that starts when the vehicle pulls away from a depot/charging location and ends when the vehicle returns to a depot/charging station. An electric vehicle block may include one or more routes or portions thereof. Of course such a block need not relate solely to a transit industry vehicle (such as a bus) but could apply to a fleet, such as cars, or delivery services, and simply people with a known route to follow. For example, when a regular driver fills in destinations on their way from home to work, in their electric vehicle, that may be considered an electric vehicle block. Before a vehicle is assigned an electric vehicle block, or a piece of work, the required SOC may be compared to the SOC historical information to ensure the vehicle is expected to be able to complete the electric vehicle block.
j. Driver dataset: a dataset including information about the driver, which may include an operator ID, age, gender, and driving characteristics (such as driving scores, efficiency scores, and the like). Driver datasets may be stored on central server 106 and may be duplicated to the on-board computing device when a piece of work is starting. An operator ID may be unique and allow other aspects of the driver dataset to be looked up, for example at central server 106.
k. Vehicle dataset: a dataset including information about the vehicle, which may include a vehicle type (full size bus, car, small bus), weight, number of tires, passenger count information, status and use of air conditioning, tire pressure. Some of the vehicle information may be obtained from a database on central server 106, such as vehicle type and standard weight. Some of the vehicle may be obtained from one or more hardware devices on the electric vehicle (such as automated passenger counters, tire pressure monitors, air conditioning and heating systems) that may communicate, via one or more CANs and/or OBD II, to processor 104 and/or on-board computing device.
l. Environmental dataset: a dataset including information about the environment the electric vehicle is operating in. For example, the temperature, elevations, road conditions (wet, snowy), traffic conditions, and the like. Environmental dataset information may be obtained from weather services or other external services (such as traffic information), vehicle hardware devices (windshield wiper use, thermometers, for example).

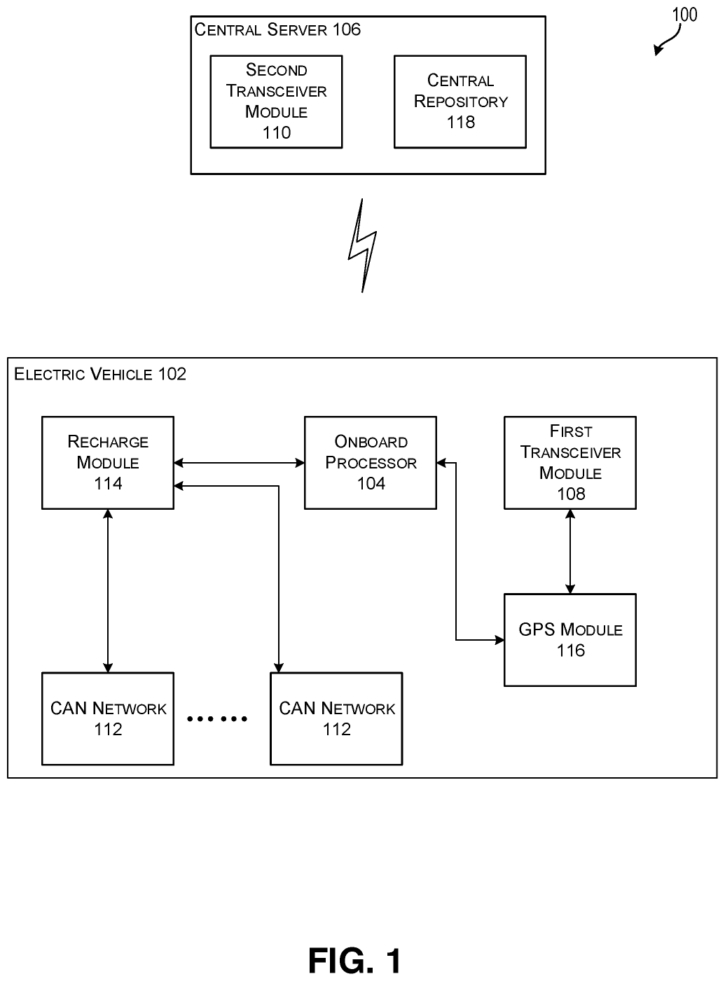

Reference hereinafter is directed to FIG. 1, which illustrates a block diagram of an on-board battery state monitoring system 100 (hereinafter referred to as system 100) for monitoring state of charge of a battery of an electric vehicle 102. The system 100 comprises an onboard processor 104 (which may be part of an integrated vehicle logic unit and/or on-board computing device) in data communication with a central server 106 of a transit agency. In one embodiment, the vehicle 102 comprises a first transceiver module 108, while the central server 106 comprises a second transceiver module 110. In one embodiment, the electric vehicle 102 is in data communication with the central server 106 via the internet. The internet connection can be facilitated by 2G, 3G, 4G, 5G, or any other telecommunication technology.

It is to be noted that in the present disclosure, the phrase “in data communication” or “communicatively connected” may refer to wireless connections (e.g., radio frequency waveforms, free-space optical waveforms, acoustic waveforms, etc.), though wired connections may also be employed, for example when electric vehicle 102 is stationed at central server 106 (or in other locations having wired connections leading to central server 106, such as transit agency yards, not shown, and the like). Examples of such connections may include: an internet, an intranet, a local area network (LAN), a wide area network (WAN), and a combination of networks, such as an internet and an intranet. Exemplary networks may operate with any of a number of protocols, such as Internet protocol (IP), asynchronous transfer mode (ATM), and/or synchronous optical network (SONET), user datagram protocol (UDP), IEEE 802.x, etc.

In accordance with the present invention, the system 100 may be designed as per the SAE J1939 practice. SAE J1939 is a vehicle bus recommended practice used for communication and diagnostics among vehicle components. The SAE J1939 defines the use of Controller Area Network (CAN) for physical and data link layers. A Controller Area Network (CAN) is a robust vehicle bus standard designed to allow microcontrollers and devices to communicate with each other in applications without a host computer. In electric vehicles or vehicles in general, CAN is a multi-master serial bus standard for connecting Electronic Control Units [ECUs] also known as nodes. Two or more nodes are required on the CAN network to communicate. A typical modern automobile may have as many as seventy such nodes or electronic control units (ECU) for various subsystems.

In the SAE J1939, messages are intended to be broadcasted by the CAN networks. This means, the messages pertaining to the different parameters of the vehicle are constantly broadcasted without any particular destination. This allows future software revisions to easily accommodate new devices. Each broadcasted J1939 message includes a Parameter Group Number (PGN), which is a unique number associated with one or more group(s) of parameters and a suspect parameter group (SPG) that has one or more pieces of data, such as SOC information.

In accordance with the present invention, the system 100 further comprises at least one CAN network 112 onboard the vehicle 102 for monitoring different parameters of the electric vehicle 102. In one general aspect of the present invention, there can be many different CAN networks that need to be monitored for checking the battery state of vehicle 102. Other CAN networks and network-connected devices may include automated passenger counting systems, accelerometers, odometers, GPS devices, and other vehicle systems.

The system 100 further comprises a recharge module 114 in data communication with the at least one CAN network 112 and the on-board processor 104. The recharge module 114 is configured to analyze the Parameter Group Numbers (PGNs) in messages broadcasted by the at least one CAN network 112 and filter out PGNs that provide state of charge of the battery (SOC information), wherein the filtered out PGNs are transmitted to the on-board processor 104 for the state of charge analysis of the battery. For example, recharge module 114 may hear each message on one or more CANs and inspect the PGN. If they PGN does not match the PGN of the battery then the message may be disregarded, otherwise it may be passed along to processor 104 or on-board computing device. Of course recharge module 114 could be programmed to listen for other PGNs (such as relating to aspects of vehicle 102 that may form part of a vehicle dataset or an environmental dataset) and similarly pass those along to processor 104 or on-board computing device, as may be required or desired.

The system 100 is configured such that the SOC information and/or SOC instruction may then be transmitted to the central server 106. More specifically, the SOC analysis (which may be processing of SOC information to determine a SOC instruction) may be performed by the onboard processor 104 or the central server 106 depending on various factors such as: the nature of the telecommunication networks and ability to communicate between the vehicle 102 and the central server 106, whether the transit service is fixed route or demand response, the vehicle type, the amount of SOC historical data that may be required for accurate SOC analysis, the storage and processing capabilities of onboard processor 104 (and associated on-board computing device, including vehicle repository, not shown).

In one embodiment the first transceiver module 108 transmits the SOC information to the central server 106. The second transceiver module 110, at the central server 106, receives the SOC information, which is used by the central server 106 for SOC analysis. The second transceiver module 110 may then reply with an SOC instruction, which may be received by the first transceiver module 108 and acted upon by the onboard processor 104 (and/or on-board computing device which processor 104 may be integral with, such as by displaying a message to a driver of electric vehicle 102). More specifically, based on the SOC analysis, the central server 106 computes if a scheduled task or transit/electric vehicle block (or the portion of the electric vehicle block that remains), which may include providing transit services to people, providing food or package deliveries, and the like, assigned to the electric vehicle 102 can be completed with the present state of charge of the battery (or is likely to be able to be completed, to an acceptable level of certainty). Success may be tracked as well (for example to store if vehicle 102 ‘made it’ or completed service if the SOC instruction was to continue), and such SOC instruction successes (SOC success data or statistics) can be monitored over time. If the central server 106 computes that the SOC is not sufficient to complete remaining portion of the scheduled task (transit vehicle block) or the risk of such is too great, the central server 106 may take one or more remedial actions such as redirecting the electric vehicle 102 to an in-service charging station available in the vicinity of the electric vehicle 102, amending the transit service, and/or dispatches another electric vehicle for completing the scheduled task (electric vehicle block).

In practice there may be one central server 106 (for example that is owned by or operated for one transit agency). There may also be one or more central servers that service multiple transit agencies and thus are able to aggregate performance for various vehicles, vehicles types and the like, under various operating conditions (number of passengers, temperature, elevation to climb to complete a service, distance to travel to complete a service, and the like). There may further be a central server that stores SOC historical data for any number of transit agencies and fleet operators (or simply drivers). This may allow a vehicle 102 to ‘ping’ central server 106 and determine if it will complete its task (transit vehicle block) and/or if is has enough charge to reach one or more known re-charge locations.

The electric vehicle 102 also comprises various systems common for vehicles, such as fixed transit buses, including but not limited to driving systems, passenger notification systems, and the like. And the electric vehicle 102 also comprises a battery (not shown) that may provide the power source to drive the vehicle 102 (in conjunction with a gas power source or as the sole power source) and may be connected to the CAN network and provides PGNs.

The electric vehicle 102 further comprises a GPS module 116 that is connected to, or part of the same device as processor 104. GPS module 116 determines the location of vehicle 102 (to include as part of the SOC information) and assists in redirecting the electric vehicle 102 to implement a remedial action such as directing the vehicle driver to an in-service charging station available in the vicinity of the electric vehicle 102.

The system 100 further comprises a central repository 118, normally in communication with the central server 106 or as a part of the central server 106. The SOC information, SOC instructions, SOC success data, and/or other data generated from the SOC analysis is stored in the central repository 118. This data (SOC historical data) will be used as historical data for more future analyses and predictions associated with the routes, vehicles, and times of day to determine impacts on efficiency of electric vehicles.

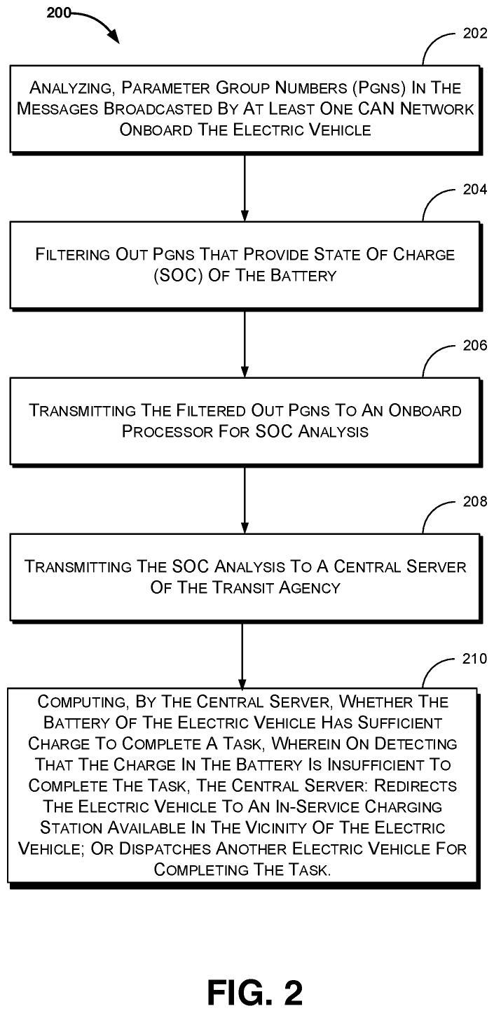

FIG. 2 illustrates a block diagram depicting the steps involved in a method for monitoring battery state of an electric vehicle. The order in which the method 200 is described is not intended to be construed as a limitation, and any number of the described method blocks can be combined in any order to implement the method or any alternative methods. Additionally, individual blocks may be deleted from the method without departing from the spirit and scope of the subject matter described herein. Furthermore, the method can be implemented in any suitable hardware, software, firmware, or combination thereof.

Reference is hereinafter directed to FIG. 2. At block 202, the method 200 includes the step of analyzing, Parameter Group Numbers (PGNs) in the messages broadcasted by at least one CAN network 112 onboard the electric vehicle 102. In an embodiment, this step is performed by the recharge module 114. Other methods may of course be employed to obtain SOC information from the battery.

At block 204, the method 200 includes the step of filtering out PGNs that provide State Of Charge (SOC) of the battery (SOC information). In an embodiment, this step is performed by the recharge module 114.

At block 206, the method 200 includes the step of transmitting the filtered out PGNs to an onboard processor for SOC analysis. In an embodiment, this step is performed by the recharge module 114.

At block 208, the method 200 includes the step of transmitting the SOC information to the central server 106 of the transit agency. In an embodiment, this step is performed by the first transceiver module 108. As described herein, the transmitting may be to the central server 106 or may be to processor 104 or on-board computing device where SOC analysis may occur.

At block 208, the method 200 includes the step of computing, by the central server 106 or on-board computing device, whether the battery of the electric vehicle has sufficient charge to complete a task (electric vehicle block, SOC instruction, or part thereof). In other words, if the SOC of the battery is enough or adequate to complete the electric vehicle block (and ideally with enough margin to be confident it is enough). This may involve, for example:
a. Obtaining the SOC information, such as by obtaining the one or more SPNs from the data field of the J1939 message having a PGN relating to the battery and converting the SPNs into SOC information such as state of charge;
b. Determining the transit service, transit vehicle block or task that vehicle 102 is performing and how much (ie what portion of the transit vehicle block) of such transit service or task remains (which may be with reference to a schedule, or route, of fixed stops for example for a fixed route vehicle or manifest for a demand response vehicle, which may be stored by scheduling systems implemented in the systems described herein and using GPS location of the vehicle 102 or steps of the manifest that a driver or software has marked as completed), where the remaining portion may comprise distances, number of fixed stops remaining, elevation changes and the like;
c. Predicting the charge required to complete the task (transit vehicle block), which may involve:
   i. Looking up historical required SOC data for the task (transit vehicle block) (such as how much charge is required to complete a fixed route, based on the location of vehicle 102 and thus how much of the fixed route “task/transit vehicle block” remains), for the vehicle (ie vehicle “x” can drive for 10 km with a SOC of 25%), for the vehicle driver, for the vehicle type (ie a vehicle of vehicle type “y” can typically drive for 15 km with a SOC of 25%, and the like) to arrive at a historical required SOC for the task (transit vehicle block);
   ii. Adjusting the historical required SOC for variables such as number of passengers (a weight increase or decrease causing a change in required SOC), time of day, traffic, temperature (batteries losing charge more in colder weather), tire pressure (reducing efficiency of use of charge), and the like, that are applicable to the current SOC analysis;
   iii. Comparing the historical required SOC to the SOC information and determining if the SOC information exceeds the adjusted historical required SOC (noting that of course the adjustments can be to the SOC information and not the historical required SOC).

On detecting that the charge in the battery is insufficient (or may be insufficient, with too great a risk to continue) to complete the task (transit vehicle block), block 208 may include determining one or more remedial actions.

Remedial actions may include:
a. Redirecting the electric vehicle (either by central server 106 or by on-board computing device) to an in-service charging station (which may be in a depot for example) available in the vicinity of the electric vehicle;
b. Changing the manifest to reduce the portion of the route that remains or having the vehicle perform a different pattern of a fixed route;
c. dispatching another vehicle for completing the task (transit vehicle block). Scheduling systems may assist in determining a location for a replacement vehicle; and
d. Provide updates and communications such as may be relevant for delays and schedule changes.

Through the system 100 and the method 200, in accordance with the present invention, the central server 106 is equipped with the data regarding the SOC of the batteries of all the active transit vehicles, or any other non-electric vehicles that may be used. Therefore, on receiving a request from a user of the transit service, the central server 106 may rely on a scheduling server (which may be part of central server 106) to determine and arrange another vehicle to meet the applicable vehicle to help complete the task (transit vehicle block).

To establish a body of SOC historical data electric vehicles 102 (for example their on-board computing devices) may be programmed to obtain SOC information from PGNs (or monitor PGNs periodically) and occasionally collect the SOC information, and eventually transmit or provide it to central server 106 (with or without other information such as temperature, GPS location, and other variables discussed herein). Such information can be stored in various ways and formats, including associating such data by variable or route. Over time, and with various transit agencies participating, SOC historical data and SOC historical required SOC, central server may have a complex map of SOC required to perform various tasks or transit services (such as point to point data, point to recharge station data, fixed route stop to fixed route stop data, and the like).

Such SOC historical data may be collected by one or more electric vehicles as they perform transit vehicle blocks, and sent to a SOC usage database (not shown). For example, vehicles 102 may have a block, run or schedule to follow. The schedule may have one or more points (fixed route stops, or manifest items like pickups and drop-offs) where system 100 would collect SOC information. This may allow SOC database to have a large set of point to point SOC reduction pairs—ie going from point 1 to point 2 reduced SOC by 2%, going from point 2 to point 3 reduced SOC by 5%—for any number of points.

In one example a transit agency may assign its vehicles 102 to routes and collect SOC information at each fixed route stop. This may be done, for example, by having on-board computing device determine when it has arrived at a stop (for example via GPS, operator input, door opening indicators, RFID, and the like) and then having recharge module listen or poll the CAN for a message that includes SOC information. Of course the battery could be polled or pinged at a given time (for example through software on vehicle 102), or if the battery broadcasts SOC information at intervals then a broadcast SOC information may be adequate providing it occurred within a reasonable amount of time from when the point was reached (say between 1-10 seconds or even within 1 minute). When the SOC information is obtained, for example by on-board computing device by way of recharge module, it can be stored in a database on on-board computing device and sent along to central server 106 (either in real-time or in bulk, for example when vehicle 102 is back at a depot). Of course various other data or datasets may be added to SOC information before it is stored and/or transmitted (such as a driver dataset from a database on the on-board computing device, a vehicle dataset and an environmental dataset) or it may be added as it is provided to central server 106.

In another example vehicle 102 (for example a transit industry vehicle) may substantially continuously or periodically (for example every second, every few seconds, every minute, or every few minutes) obtain its SOC information, determine the number of miles it should be able to drive based on the SOC information, and compare that to the miles it has left to perform in its electric vehicle block. If the miles it has left (the portion of the electric vehicle block that remains) exceeds the miles it should be able to drive, then a message may be presented to a driver, for example via on-board computing device, and a remedial action may be determined (either by on-board computing device and/or by central server 106).

These two examples, and other similar examples, may also be used together. For example, GIS data may be used as part of an environmental dataset, which would give insights into a slope or elevation change for the portion of the electric vehicle block. That may be used to adjust the miles vehicle 102 may be able to drive, or adjust the portion of the electric vehicle block. Without GIS data, having point to point SOC reduction data (ie going from point 1 to point 2 reduced SOC by 2%) may allow better predictions of whether the SOC remaining will allow vehicle 102 to complete the portion of the electric vehicle block that is remaining.

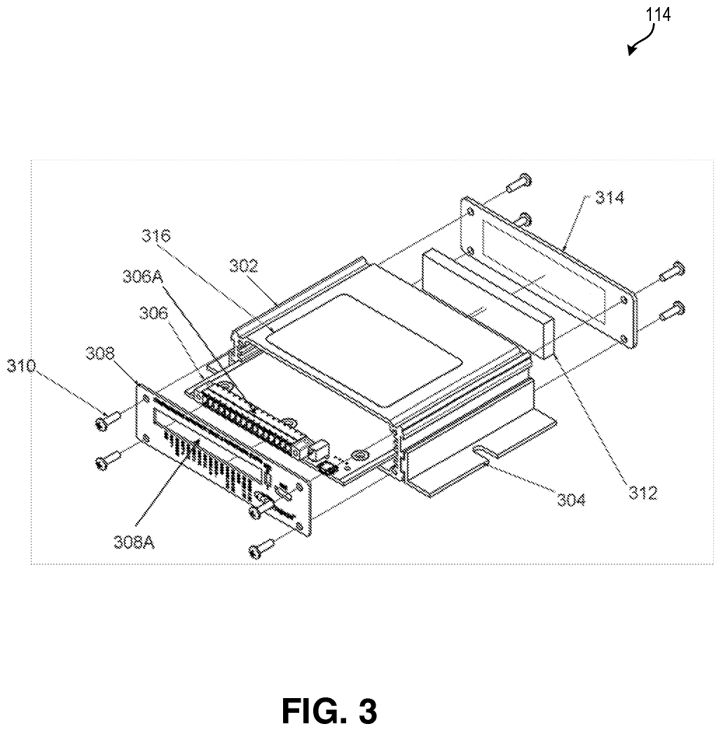

FIG. 3 illustrates an exploded isometric view of the recharge module 114, in accordance with an embodiment of the present invention. As illustrated in FIG. 3, the recharge module 114 is in a form of a dongle. The recharge module 114 comprises a housing 302. The housing 302 can be of any shape. In the present embodiment, the housing 302 has a rectangular profile. The housing 302 has mounting flanges 304 extending from the lateral sides thereof. The recharge module 114 further comprises a printed circuit board assembly 306 configured to be disposed within the housing 302. The recharge module 114 further comprises a front cover 308 that has a slot 308A. In an assembled configuration, the slot on the front cover provides access to connectors 306A on the printed circuit board assembly 306. Fasteners 310 are used for connecting the front cover 308 to the housing 302. The recharge module 114 further comprises a foam strip 312 to be disposed between the rear end of the printed circuit board assembly 306 and a rear cover 314 for snugly fitting the printed circuit board assembly 306 within the housing 302. A label 316 can be provided on the operative top surface of the housing 302. Recharge module 114 may be communicatively connected to the CAN network for example via connectors 306A.

The embodiments of the systems and methods described herein may be implemented in hardware or software (including firmware), or a combination of both. These embodiments may be implemented in computer programs executing on programmable computers (such as on-board computing device, transit agency server and the like), each computer including at least one processor, a data storage system (including volatile memory or non-volatile memory or other data storage elements or a combination thereof), and at least one communication interface. In certain embodiments, the computer may be a digital and/or any analogue computer.

Program code is applied to input data to perform the functions described herein and to generate output information. The output information is applied to one or more output devices, in known fashion, such as screens on on-board computing device (not shown).

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., read-only memory (ROM), magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, nontransitory computer readable medium that bears computer usable instructions for one or more processors. The medium may be provided in various forms, including one or more diskettes, compact disks, tapes, chips, magnetic and electronic storage media, and the like. Non-transitory computer-readable media comprise all computer-readable media, with the exception being a transitory, propagating signal. The term non-transitory is not intended to exclude computer readable media such as a volatile memory or random access memory (RAM), where the data stored thereon is only temporarily stored. The computer useable instructions may also be in various forms, including compiled and non-compiled code.

Although embodiments for monitoring state of charge of a battery of an electric vehicle have been described in language specific to structural features and/or methods, it is to be understood that the invention is not necessarily limited to the specific features or methods described. Rather, the specific features and methods are disclosed as exemplary embodiments of the system and the method described herein.

What is claimed is:

1. An on-board battery state monitoring system for monitoring state of charge (SOC) of a battery of an electric vehicle, the system comprising:
an on-board computing device, on the electric vehicle, in data communication with a central server and a recharge module via one or more controller area networks (CAN);
a battery of an electric vehicle, the battery in data communication with a first CAN for broadcast of a first message to the first CAN, the first message comprising a first parameter group number (PGN) related to the battery and SOC information of the battery;
the first CAN for receiving the first message and broadcasting the first message; and
the recharge module in data communication with the first CAN network and the on-board computing device, the recharge module configured to:
receive a set of one or more messages from one or more CAN networks;
analyze the PGNs of each message of the set of messages to search for the first PGN;
filter out the first message from the set of messages based on searching for the first PGN; and
transmit the first message to the on-board computing device for a SOC analysis of the battery.

2. The system of claim 1 wherein the SOC analysis comprises determining, from the SOC information, if a SOC of the battery is enough to complete an electric vehicle block for the electric vehicle.

3. The system of claim 2 wherein the SOC analysis further comprises:
obtaining the SOC information from a suspect parameter number (SPN) of the message;
determining the electric vehicle block and a portion of the electric vehicle block that remains;
predicting the SOC required for the portion of the electric vehicle block that remains.

4. The system of claim 3 wherein the predicting further comprises:
looking up a historical required SOC for the portion of the electric vehicle block that remains;
adjusting the historical required SOC or the SOC based on a set of variables; and
comparing the historical required SOC to the SOC.

5. The system of claim 4 wherein the SOC analysis is performed by the on-board computing device or the central server.

6. The system of claim 1 wherein based on the SOC analysis, an SOC instruction is computed and a remedial action is suggested and communicated to the on-board computing device, wherein the on-board computing device is further configured to display the remedial action.

7. The system of claim 6 wherein the on-board computing device is further configured to perform the SOC analysis and the central server is further configured to compute the SOC instruction.

8. The system of claim 6 wherein the remedial action comprises redirecting the electric vehicle to an in-service charging station available in the vicinity of the electric vehicle and redirecting steps are displayed on the on-board computing device.

9. The system of claim 6 wherein the remedial action comprises dispatching another vehicle for completing the portion of the electric vehicle block that remains.

10. A method for monitoring battery state of a battery of an electric vehicle, the method comprising:
analyzing, Parameter Group Numbers (PGNs) in a set messages broadcasted by at least one CAN network onboard the electric vehicle;
filtering out messages that provide state of charge (SOC) of the battery based on the analyzing;
transmitting the filtered out messages for SOC analysis; and
performing SOC analysis to determine whether the battery of the electric vehicle has sufficient charge to complete a portion that remains of an electric vehicle block to be performed by the electric vehicle.

11. The method of claim 10 wherein on detecting that the SOC of the battery is insufficient to complete the portion that remains of the electric vehicle block, computing a remedial action; and
communicating the remedial action to an on-board computing device on the electric vehicle, to be displayed on the on-board computing device.

12. The system of claim 11 wherein the SOC analysis further comprises:
determining the electric vehicle block and a portion of the electric vehicle block that remains; and
predicting the SOC required for the portion of the electric vehicle block that remains.

13. The system of claim 12 wherein the predicting further comprises:
looking up a historical required SOC for the portion of the electric vehicle block that remains;
adjusting the historical required SOC or the SOC based on a set of variables; and
comparing the historical required SOC to the SOC.

14. The system of claim 13 wherein the remedial action comprises redirecting the electric vehicle to an in-service charging station available in the vicinity of the electric vehicle or dispatching a second electric vehicle for completing the task.

15. A method for establishing a body of state of charge (SOC) historical data for batteries of electric vehicles comprising:
assigning an electric vehicle block to be performed by an electric vehicle;
specifying a set of two or more points, on the electric vehicle block, at which to collect SOC information while performing the electric vehicle block;
collecting, by an on-board computing device in data communication with a recharge module, the recharge module in data communication with a first controller area network (CAN) that is in data communication with a battery of the electric vehicle, the SOC information at the each of the points in the set while performing the electric vehicle block;
sending the collected SOC information to a SOC usage database; and
storing the collected SOC information in the SOC usage database to establish the body of SOC historical data.

16. The method of claim 15 wherein the collecting further comprises the on-board computing device being configured to, for each point in the set:
identify an arrival of the electric vehicle at the points; and
poll the recharge module to obtain the SOC information from the battery.

17. The method of claim 15 wherein the electric vehicle block is a fixed route transit route and the one or more point to point SOC usage values to collect are at each fixed route stop on the fixed route transit route.

18. The method of claim 15 wherein the SOC information comprises a SOC, a driver dataset from a database on the on-board computing device, a vehicle dataset and an environmental dataset and wherein the on-board computing device is further configured to:
ping one or more CANs to obtain the vehicle dataset; and
collect the environmental dataset.
